(19) United States
(12) Patent Application Publication
(10) Pub. No.: US 2012/0257374 A1
(43) Pub. Date: Oct. 11, 2012

(54) LED LAMP

(75) Inventor: Muessli DANIEL, Biel (CH)

(73) Assignee: Futur-Tec (Hong Kong) Limited, Hong Kong (CN)

(21) Appl. No.: 13/080,637

(22) Filed: Apr. 5, 2011

(51) Int. Cl. F21V 29/00; F21V 21/00

(52) U.S. Cl. 362/84; 362/249.02

(57) ABSTRACT

An LED lamp is disclosed herein. The LED lamp may comprise a core with a plurality of outwardly extending elevated sections configured to dispose LED supports. The core may comprise one or more air vents. A heat sink may be disposed in conductive heat transfer communication with a corresponding LED support. An insulator may be disposed about each embossed portion of the core and may have a light redirecting portion configured to redirect light emitted from LEDs supported on a corresponding LED support. One or more heat sinks and its corresponding insulator may be configured and disposed to provide an air gap therebetween.

### FIELD OF THE DISCLOSURE

This disclosure relates generally to lamps, and more particularly, to a light emitting diode (LED) lamp comprising a plurality of LEDs disposed therein and configured to dissipate heat generated by the plurality of LEDs.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Incandescent light bulbs have been and are currently used in a large variety of lighting products. An incandescent light bulb or lamp produces light by heating a metal filament wire to a high temperature until it glows. The hot filament is protected from air by a glass bulb that is filled with inert gas or evacuated. Most lamps are configured to be used in a socket and comprise a base, such as an Edison screw base or any other type standard base such as GU5.3 or GU10.

Even though incandescent light bulbs are relatively inexpensive, as compared to alternative light sources, incandescent light bulbs have several drawbacks. For example, incandescent light bulbs use a relatively large amount of power compared to other lighting products which increase energy costs. Also, incandescent light bulbs have a relatively short life causing repetitive replacement costs.

Recently, fluorescent lamps, particularly compact fluorescent lamps (CFLs), have been developed to overcome some of the drawbacks associated with the incandescent lamps. For example, fluorescent lamps are more efficient and have a longer life than incandescent lamps. A fluorescent lamp is a gas-discharge lamp that uses electricity to excite mercury vapor. The excited mercury atoms produce short-wave ultraviolet light that then causes a phosphor to fluoresce, producing visible light. Fluorescent lamps convert electrical power into useful light more efficiently than incandescent lamps, lowering energy costs. Larger fluorescent lamps are mostly used in commercial or institutional buildings and CFLs have been developed to be used in the similar manner as incandescent. Even though fluorescent lamps have overcome some of the drawbacks associated with the incandescent lamps, drawbacks remain. For example, fluorescent lamps contain mercury which is hazardous to human health and they may have a delayed response time when turning on the lamp.

More recently, light emitting diode (LED) lamps have been developed to overcome some of the drawbacks associated with the incandescent and fluorescent lamp. An LED lamp is a solid-state lamp that uses LEDs as the source of light. An LED may comprise a conventional semiconductor light emitting diode or an organic or polymeric light emitting diode. The light emitted by an LED is caused by the generation of photons from materials within the LED and is not the product of an electrical current passing through an illuminating filament. LED lamps may have one or more advantages over fluorescent lamps, for example, LED lamps do not contain mercury, they may turn on instantly, they may have a longer service life, they may have a smaller size, and they may have a greater efficiency.

However, currently available LED lamps may not be well suited for some lighting applications. For example, LED lamps may require a plurality of LEDs to provide a desired amount of light generation which may generate excessive heat. The heat generated from the LEDs may accumulate within the lamp and raise the operating temperature of the LEDs. Operating LEDs at a higher temperature may adversely affect the service life of the LED lamp. Currently available LED lamps may be insufficient for dissipating the generated heat. Additionally, currently available LED lamps may require complex heat management systems to dissipate heat generated by the LEDs. Further, many currently available LED lamps may not provide a desired aesthetic replacement for incandescent lamps used in some luminaires. Such requirements and/or desirabilities may introduce obstacles in designing LED lamps.

What is needed is an LED lamp that overcomes some of the obstacles and/or desirabilities associated with currently available LED lamps.

### SUMMARY

In one aspect of the present disclosure, an LED lamp comprises a core comprising a plurality of elevated sections. Each elevated section comprises at least one air vent and may be configured to dispose an LED support. The LED lamp may comprise a heat sink in conductive heat transfer communication with a corresponding LED support. Each heat sink may comprise a plurality of convective heat transfer fins extending outward from its corresponding LED support. Each heat transfer fin may be gap spaced from adjacent heat transfer fins on each heat sink. The LED lamp may comprise an insulator disposed about each embossed portion of the core and may have a light redirecting portion configured to redirect light emitted from LEDs supported on its corresponding LED support. Each insulator may comprise at least one air vent in its light redirecting portion. Each heat transfer fin and each corresponding insulator may be configured and disposed to provide an air gap therebetween. The LED lamp may comprise a light transmissible panel disposed about a light opening in each insulator and each light transmissible panel may have an air gap between an adjacent light transmissible panel. Each air vent in each embossed portion, each air vent in each insulator, each gap space between heat transfer fins, each air gap between heat transfer fins and a corresponding insulator, and each air gap between adjacent light transmissible panels may be configured and disposed to be in air flow communication with each other and an outside environment.

In another aspect of the present disclosure, an LED lamp comprises a core configured to support a plurality of LED supports, an insulator disposed about each LED support, a heat sink disposed about each insulator, and at least one insulator and heat sink disposed thereabout having an air gap therebetween.

In a further aspect of the present disclosure, an LED lamp comprises a core comprising a plurality of outwardly extending elevated sections wherein each elevated section is configured to dispose an LED support.

### BRIEF DESCRIPTIONS OF THE DRAWINGS

The following figures, which are idealized, are not to scale and are intended to be merely illustrative of aspects of the present disclosure and non-limiting. In the drawings, like elements may be depicted by like reference numerals. The drawings are briefly described as follows.

FIG. 1 is a perspective view of an LED lamp showing the disposition of light transmissible panels and air gaps therebetween;

FIG. 2 is an exploded view of a portion of the LED lamp of FIG. 1 showing LEDs disposed within a lighting chamber;

FIG. 3 is an exploded view of a portion of the LED lamp of FIG. 1 showing heat sinks disposed about the lighting chamber;

FIG. 4 is an exploded view of a portion of the LED lamp of FIG. 1 showing a core configured to support the component parts thereof;

FIG. 5 is an exploded view of a core showing elevated sections and air vents therein;

FIG. 6 is a perspective view of a base; and

FIG. 7 is a cross-sectional view of a portion of the LED lamp of FIG. 1 showing the disposition and configuration of component parts thereof.

### DETAILED DESCRIPTION

Reference will now be made in detail to the present exemplary embodiments and aspects of the present invention, examples of which are illustrated in the accompanying figures. Wherever possible, the same reference numbers will be used throughout the figures to refer to the same or like parts.

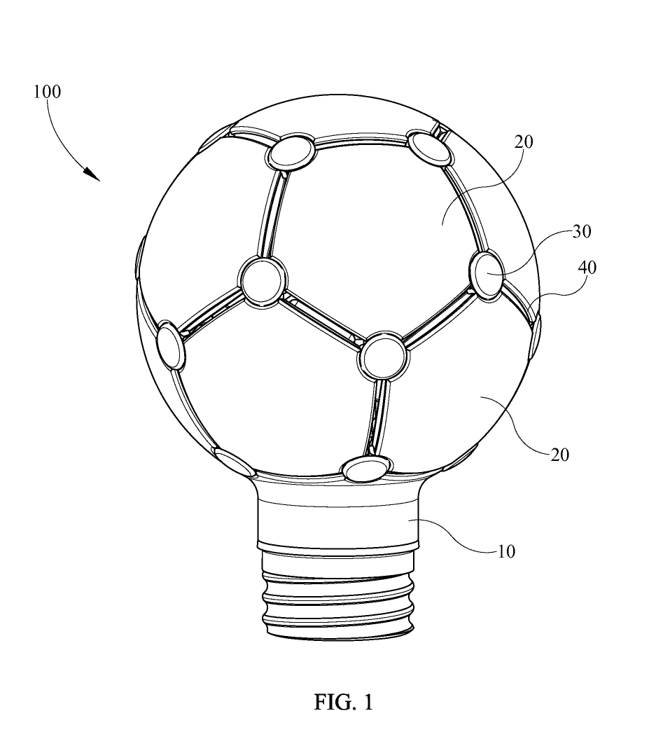

FIG. 1 shows LED lamp 100 and the disposition of vent openings and other external components and features. LED Lamp 100 is shown as comprising a base 10 with a connector configured to connect LED lamp 100 to existing lamp sockets. Base 10 may comprise an Edison screw base, as shown, a bi-pin base, a bayonet, or other connector configured to connect LED lamp 100 to a lamp socket. Alternatively, LED lamp 100 may be configured to connect with any type of socket or may be a component part of a luminaire, hence not comprise a connector.

LED lamp 100 may comprise a plurality of light transmissible panels 20. Light transmissible panels 20 may have a polygonal geometric shape such as triangular, rectangular or square, pentagonal, hexagonal, or may have seven or more sides. Light transmissible panels 20 may be substantially flat or may bow outwardly. LED lamp 100 may have a cube, tetrahedron, octahedron, dodecahedron, icosahedron, or other shape. In the aspect shown in FIG. 1, light transmissible panels have a pentagonal configuration. Each light transmissible panel 20 may be disposed about LED lamp 100 with an air gap 40 between the edges of adjacent light transmissible panels 20. Air gaps 40 may be configured and disposed to provide cooling air inlets and outlets for convective cooling air to pass through at least a portion of LED lamp 100.

Light transmissible panels 20 may be substantially clear, opaque, translucent, or transparent and may have an inner surface configured to scatter light passing therethrough. In at least one aspect, light transmissible panels 20 have a phosphor containing material disposed therewith. A phosphor containing material may be coated on a surface of a light transmissible panels 20 or may be doped therein. Light transmissible panels may comprise glass or polymeric materials such as acrylic or PMMA. In at least one aspect, LED lamp 100 may be referred to as a remote phosphor lamp as the LEDs 62 in lamp 100 may not have phosphor. In at least one other aspect, light transmissible panels 20 may not have phosphor. In this aspect, LEDs 62 in lamp 100 may have phosphor.

Interlock pins 30 may be configured and disposed to hold light transmissible panels 20 about an outer surface of LED lamp 100. Interlock pins 30 may have a rounded head as shown or may have a polygonal shaped head. Air gaps 40 may be disposed between interlock pins 30 and light transmissible panels 20.

LED lamp 100 may have a variety of shapes, for example, LED lamp 100 may be a globe lamp with a rounded or spherical shape as shown. However, it is to be understood that LED lamp 100 may have a variety of shapes such as an A-Shape, GLS, flame, or other standard shape. Additionally, LED lamp 100 may have a geometric shape or polyhedron shape such as a cube, tetrahedron, octahedron, dodecahedron, icosahedron, or other shape as is known in the art. In at least one aspect, LED lamp 100 is a dodecahedron with insulated lighting chambers.

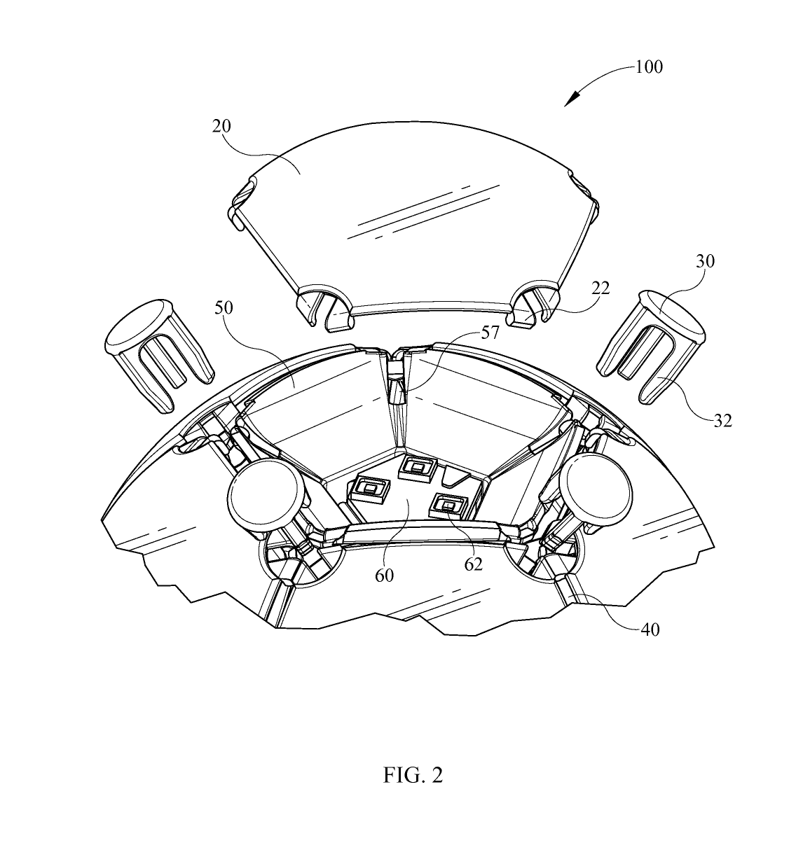

FIG. 2 shows an exploded portion of the LED lamp 100 showing LEDs 62 disposed within a lighting chamber. Interlock pins 30 and a light transmissible panel 20 are shown removed from a portion of LED lamp 100, exposing a lighting chamber. A lighting chamber may have an LED support 60, supporting a plurality of LEDs 62, and an insulator 50.

Light transmissible panels 20 may have connecting portions 22 disposed at corners thereof configured to cooperate interlock pins 30. Insulators 50 may have insulator connector portions 57 disposed at corners thereof configured to cooperate interlock pins 30. Interlock pins 30 may have a plurality of interlock pin legs 32 configured and disposed to cooperate with light transmissible connecting portions 22 and insulator connecting portions 57. Interlock pins 30 may be configured to removably hold light transmissible panels 20 to a corresponding insulator 50.

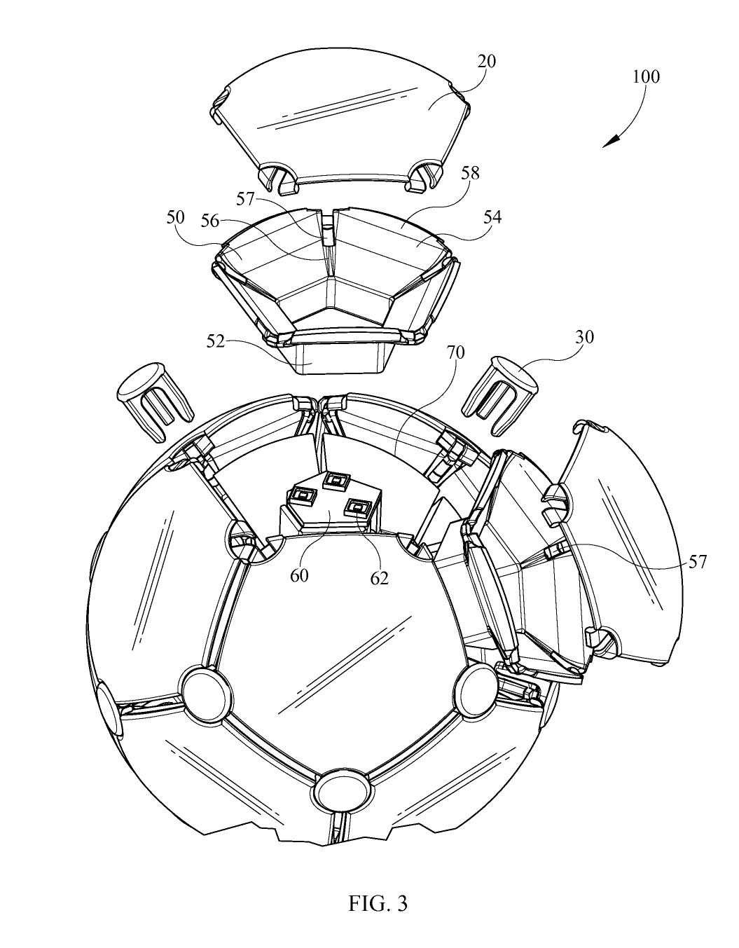

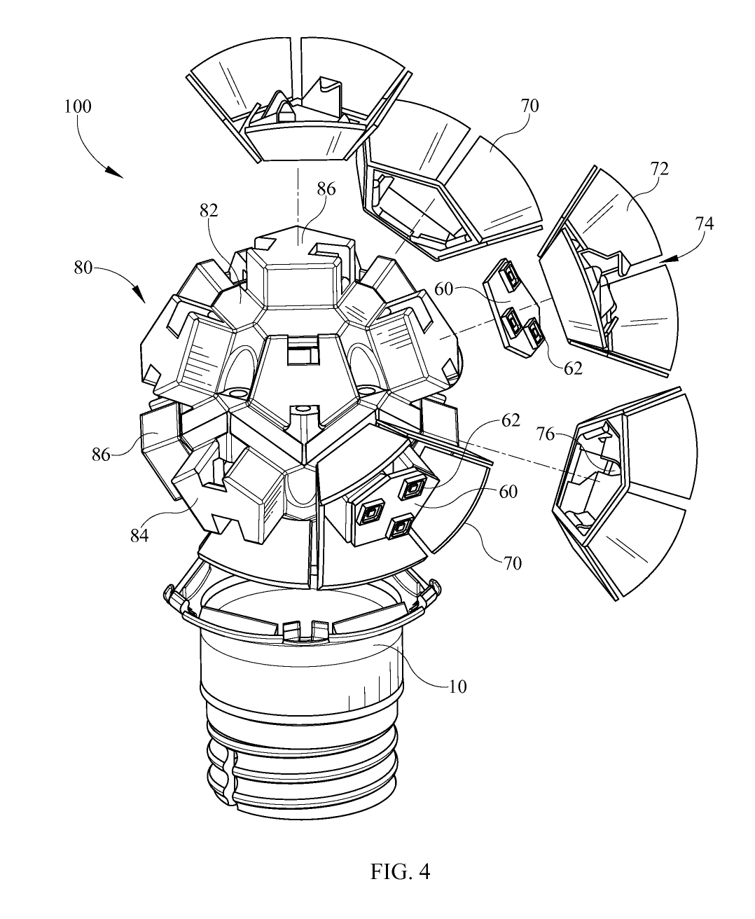

FIG. 3 shows LED lamp 100 having an insulator 50 removed therefrom. Insulator 50 may be comprised of an electrical insulating material. Insulator 50 may be also be comprised of a heat conductive material. For example, insulator 50 may comprise one or materials that are both electrically insulating and thermally conductive. An inner surface 54 of insulator 50 may be configured and disposed to reflect light emitted from LEDs 62, in the lighting chamber, out of LED lamp 100 through a light transmissible panel 20. For example, an inner surface of insulator 50 may be have a light color or may be coated with light reflecting material. An outer and/or inner surface of insulator 50 may be configured to transfer heat to convective air flowing thereabout. For example, an outer surface of insulator 50 may be rough and/or have a coating material configured to improve convective heat transfer therefrom. Insulators 50 may have a base 52 configured to cooperate with a portion of a core 80, shown in FIG. 4. Insulators 50 may have one or more air vents 56 disposed therein. Air vents 56 may be configured to provide convective air flow through the lighting chamber. Insulators 50 may also have flanges 58 configured to dispose light transmissible panels 20. A heat sink 70 may be disposed about each insulator 50.

FIG. 4 shows portions of LED lamp 100 having heat sinks 70 and LED supports 60 removed from a core 80. Heat sinks 70 may be comprised of a heat conductive material configured to conduct heat from LEDs 62 disposed with LED support 60. Heat sinks 70 may have an inner surface, an outer surface, or both surfaces configured and disposed to convect heat therefrom. For example, heat sinks 70 may have an outer contour and/or have a coating material configured to improve convective heat transfer therefrom. Heat sinks 70 may comprise a plurality fins 72 configured and disposed to extend outwardly about a corresponding insulator 50. Heat sinks 70 may have vents 74 disposed therebetween. Heat sinks 70 may also comprise connecting tabs 76 configured and disposed to connect heat sinks 70 to core 80. Connecting tabs 76 may be configured to be disposed with an LED support 60 such that heat may be conducted from LEDs 62. Connecting tabs 76 may also be configured to dispose a corresponding LED support with core 80.

In at least one aspect, LED lamp 100 may be void of a core 80. For example, connecting tabs 76 may be configured to interconnect a plurality of insulators 50 to form a geometric shape. An LED support 60 may be disposed with each insulator 50. A heat sink 70 may be disposed about each insulator 50 wherein at least one insulator 50 and heat sink 70 may be disposed thereabout with an air gap therebetween. Additionally, insulators 50 may be disposed with air gaps 40 therebetween.

Core 80 may comprise an upper portion 82 and a lower portion 84. Such a multi-component core may aid in manufacturing of LED lamp 100. Core 80 may comprise a plurality of elevated sections 86. Each elevated section 86 may have a geometrical configuration similar to a geometrical configuration of a corresponding light transmissible panel 20. For example, in the aspect of LED lamp 100 shown in the figures, each elevated section has a pentagonal configuration as does each heat sink 70, insulator 50, and corresponding light transmissible panel 20. However, it is to be understood that elevated sections 86 may be rounded or have any number if sides. Additionally, core 80 may be void of elevated sections 86.

Elevated sections 86 may be configured to dispose an LED support 60 on an outer surface thereof. LED supports 60 may be configured to support and electrically mount a plurality of LEDs 62. LED support 106 may comprise a printed circuit board (PCB), metal core printed circuit board (MCPCB), a chip on board (COB), and/or other LED support devices or materials as are known in the art. LED support 106 may comprise a thermally conductive material. LEDs 62 may comprise a semiconductor light source such as a conventional light emitting diode or an organic or polymeric light emitting diode semiconductor light source such as OLEDs, LEDs, and opto-electrical devices.

Each lighting chamber in LED lamp 100 may be controlled independently or dependently. A lighting chamber may be formed with a corresponding LED support 60, insulator 50, and light transmissible panel 20, disposed with an elevated section 86. For example, light intensity and/or color may be adjusted within one or more lighting chambers or all lighting chambers simultaneously. In at least one aspect, a substantially equal luminosity may be set for each lighting chamber. In at least one other aspect, one or more lighting chambers may be configured to emit a different light intensity than other lighting chambers. For example, a lighting chamber opposite base 10 may be configured to emit a higher light intensity than other lighting chambers. A higher light intensity may be accomplished by providing additional LEDs 62 in the lighting chamber, providing a highly reflective inner surface of insulator 50, having the lighting chamber void of a light transmissible panel 20, and/or providing a lens in place of a light transmissible panel 20 about that lighting chamber, for example.

An LED support 60 may support one or more LEDs 62 within a lighting chamber. The LEDs 62 within a lighting chamber may be similar or different. For example, an LED support 60 may support a combination of Red, Green, Blue, White (RGBW) LEDs 62; RGBW-Amber LEDs 62; LEDs 62 of different color temperature; LEDs 62 having the same color; or Blue/UV-LEDs 62 in combination with a remote phosphor disposed with light transmissible panels 20. In at least one aspect, LEDs 62 may have Blue-LEDs whose radiant energy may be converted into visible light by a remote phosphor coating disposed within or on an inner surface of light transmissible panels 20. In at least one other aspect, each lighting chamber may comprise both phosphor coated LEDs 62 and Blue-LEDs 62 supported on an LED support 60. In this aspect, light transmissible panels 20 may have an amount of phosphor disposed therewith to provide remote phosphor light with the Blue-LEDs 62 and a transparency sufficient to allow at least a portion of the light emitted from the phosphor coated LEDs 62 to pass therethrough.

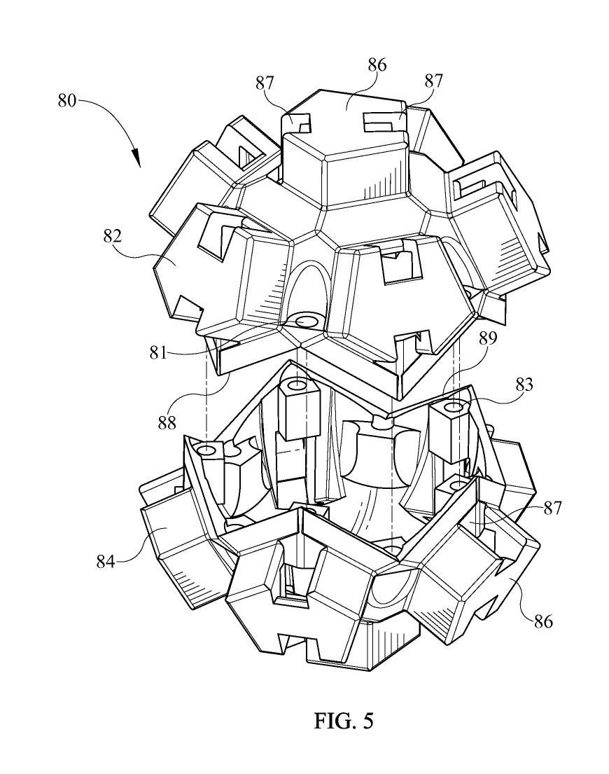

FIG. 5 is an exploded view of core 80 showing an arrangement and configuration elevated sections 86 and air vents 87 therein. In at least one aspect of the present disclosure, LED lamp 100 is configured to have cooling air pass substantially throughout the lamp. For example, core 80 may have one or more air vents 87 disposed therein configured to provide for the passage of convective flow through core 80. In the aspect shown, elevated sections 86 have air vents 87 disposed proximate an outer surface configured to dispose an LED support 60. In this aspect, convective air flow may pass through core 80 and about LEDs 62. Inner and/or outer surfaces of core 80 may be coated or otherwise configured to increase convective heat transfer therefrom. However, it is to be understood that core 80 may have air vents between elevated sections 86, may be potted, may not have air vents, and/or may be configured to conduct heat throughout.

Core 80 may have any configuration and may have any number of elevated sections 86. A rounded configuration, as shown in FIG. 5, may be advantageous to provide a globe lamp. It may be advantageous to have an oblong or tube shaped core 80 to provide an A-shaped lamp. In at least one aspect, core 80 may be void of elevated sections 86, rounded, smooth, faceted, or have other configurations. Additionally, core 80 may have other configurations for providing standard shaped lamps, for example. In at least one other aspect, LED lamp 100 may comprise a core void of elevated sections 86 and may comprise insulated lighting chambers formed with insulators 50 disposed with core 80.

In at least one aspect, core 80 has a plurality of similarly shaped elevated sections 86. For example, in the aspect shown in FIG. 5, core 80 may have a plurality of pentagonal shaped elevated sections substantially equidistantly spaced about an outer surface thereof. However, it is to be understood that elevated sections 86 may be round or have other polygonal configurations. In at least one other aspect, elevated sections 86 may have a common configuration as a corresponding heat sink 70, insulator 50, and light transmissible panel 20, supported therewith. The number and spacing of elevated sections 86 disposed with core 80 may vary and may be dependent upon the number of and the luminosity of LEDs 62 disposed within a lighting chamber and a desired light intensity of LED lamp 100.

Core 80 may comprise one or more parts for ease of manufacture. Component parts of core 80 may be symmetrical. For example, core 80 may have an upper portion 82 and a lower portion 84. Having a multi-component core 80 may improve and/or reduce the cost of manufacture. In the multi-component aspect of core 80 shown in FIG. 5, the upper portion 82 has an upper mating portion 88 and the lower portion 84 has a lower mating portion 89. Upper mating portion 88 and lower mating portion 89 may be configured and disposed to mate with each other to provide a substantially uniform core 80. Upper portion 82 may have an upper fastener portion 81 and lower portion 84 may have a lower fastening portion 83. Upper fastening portion 81 and lower fastening portion 83 may be configured to fasten upper portion 82 with lower portion 84 with or without a fastener such as a screw, rivet, adhesive, or other fastening device.

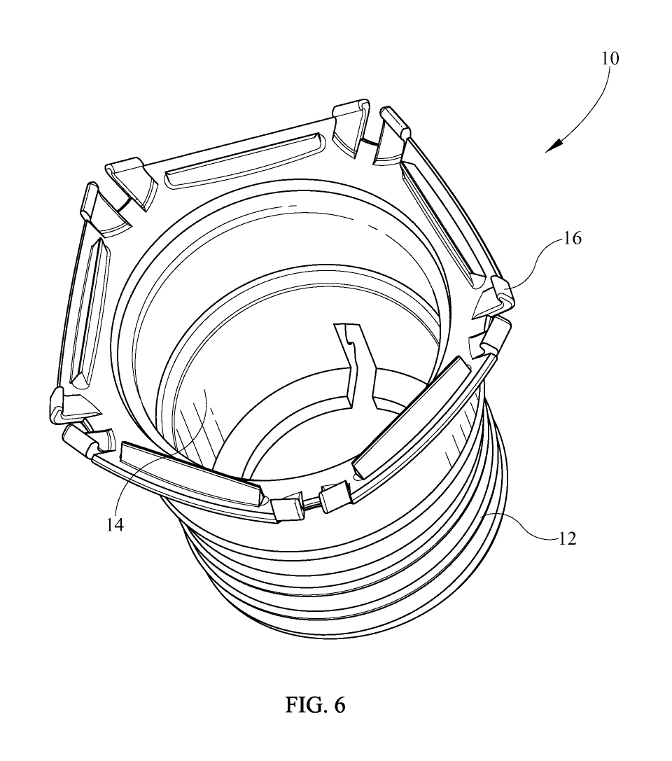

FIG. 6 shows an aspect of a base 10 that may be disposed with an LED lamp 100. In this aspect, base 10 has connectors 16 disposed about an upper perimeter thereof. Connectors 16 may be configured to cooperate with interlock pins 30. The upper perimeter of base 10 may have a similar shape as light transmissible panels 20 and may be configured have an air gap 40 between its upper perimeter and light transmissible panels 20 disposed adjacent therewith. Base 10 may have an inner annular surface 14 and may be configured to house an LED driver. Base 10 may have a connector portion 12 which may be configured to dispose a connector such as an Edison screw type connector. However, it is to be understood that connector portion 12 may be configured to disposed other connectors such as, a bi-pin base, a bayonet, or other connector configured to connect LED lamp 100 to a lamp socket. Alternatively, base connector portion 12 may be configured to dispose a connector configured to connect with any type of socket or may be a component part of a luminaire, hence not support a connector. It is to be understood that LED lamp 100 may not have a standard base 10 or may not have a base. For example, in at least one aspect, LED lamp 100 may have light transmissible panels 20 disposed substantially thereabout and may have an electrical connection extending between light transmissible panels 20.

Circuitry for driving LEDs 62 may be housed in base 10 or in core 80. The circuitry may be configured to rectify AC power and/or convert voltage. For example, LEDs 62 may be DC-driven and the power source may be AC and the circuitry may be configured to convert the alternating mains voltage into an appropriate DC voltage. Alternatively, LEDs 62 may be AC-driven and/or the power source may be DC. Therefore, the circuitry housed in LED lamp 100 may be configured to provide LEDs 62 with a desired power from a desired power source. In at least one aspect, LED lamp 100 may comprise a control system with one or more microcontrollers and/or drivers. The control system may be configured to control light parameters such as intensity, color, on/off status, or other lighting parameters, for example. The control system may also be configured to control lighting parameters in one or more lighting chambers independently. For example, color and/or intensity in selected lighting chambers may be changed or even set to flash.

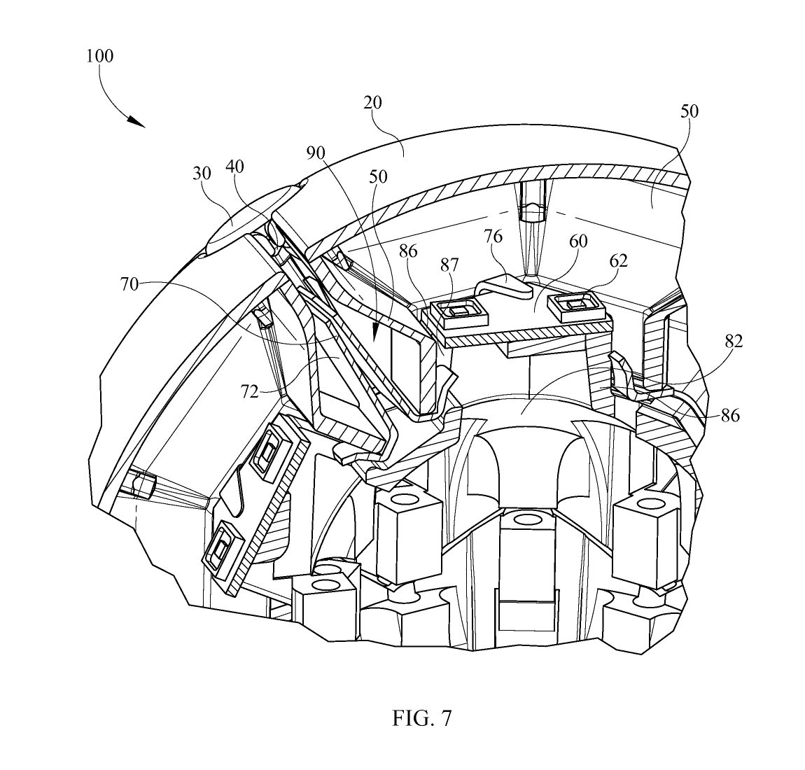

FIG. 7 is a cross-sectional view of a portion of the LED lamp 100 showing the disposition and configuration of component parts thereof. Upper portion 82 of core 80 may have elevated sections 86 configured to dispose an LED support 60. Core 80 may have one or more air vents 87 disposed therein. Each LED support 60 may dispose one or more LEDs 62. An insulator 50 may have a base 52 configured to cooperate with an elevated section 86 and be supported therewith. A heat sink 70 may be disposed about an insulator 50 and may have a portion extending into air vent 87, providing connectivity between core 80 and heat sink 70. Heat sink 70 may have connecting tabs 76 configured and disposed to hold LED support 60 adjacent an outer surface of an elevated section 86. Interlock pins 30 may be configured to removably hold light transmissible panels 20 about a light opening of insulators 50.

LED lamp 100 may be configured to permit convective air to flow substantially throughout. For example, insulator 50 and heat sink 70 may be configured and disposed to have an air gap 90 therebetween. Fins 72 of a heat sink 70 may have a gap space between the fins 72 of an adjacent heat sink 70. In this aspect, each air vent 87 in each embossed portion or elevated section 86, each air vent 56 in each insulator 50, each gap space between adjacent heat transfer fins 72 of adjacent heat sinks 70, each vent 74 in heat sinks 70, and each air gap 90 between each corresponding heat sink 70 and insulator 50 may be configured and disposed to be in air flow communication with each other and an outside environment.

In at least one aspect of LED lamp 100, component parts thereof may be removable and may be replaceable. For example, interlock pins 30 may be removed or unsnapped from an insulator 50 which may release a corresponding light transmissible panel 20. Connecting tabs 76 may configured to releasably hold an LED support 60. LED supports 60 may have connectors in wiring extending from LEDs 62 to the LED driver circuitry allowing the replacement of LEDs 62 within the lighting chamber.

LED lamp 100 may be actively or passively cooled with convective air currents. For example, an active cooling system may comprise a fan which may be housed in core 80 and may be configured and disposed to increase air flow through LED lamp 100. A passive cooling system may cool LED lamp 100 with natural convective air currents through and about component parts thereof.

Aspects of the present disclosure provide LED lamps that may be retrofitted into existing luminaires. Other aspects of the present disclosure may also provide complete LED fixtures, fixture modules, luminaires, illuminates, or other lighting apparatuses. For example, aspects of the present disclosure may comprise non replaceable LED lamp(s) permanently mounted in a luminaire or other lighting apparatus. In this aspect, the LED lamp(s) may comprise a standard connector or industry standard base configuration or the LED lamp(s) may be a non removable part of the lighting apparatus and may not comprise an industry standard base configuration.

The invention is illustrated by example in the drawing figures, and throughout the written description. It should be understood that numerous variations are possible while adhering to the inventive concept. Such variations are contemplated as being a part of the present disclosure.

### AT LEAST A PARTIAL LIST OF NOMENCLATURE

100 LED lamp
10 Base
12 Base Connector Portion
14 Inner Surface of Base
16 Base Connector
20 Light Transmissible Panel
22 Panel Connecting Portions
30 Interlock Pin
32 Interlock Pin Leg
40 Air Gap
50 Insulator
52 Insulator Base
54 Insulator Light Reflecting Portion
56 Vent in Insulator
57 Insulator Connecting Portion
58 Flange
60 LED Support
62 Light Emitting Diode
70 Heat Sink
72 Fin
74 Vent
76 Connecting Tab
80 Core
81 Upper Fastener Portion
82 Upper Portion of Core
83 Lower Fastener Portion
84 Lower Portion of Core
86 Elevated section
87 Air Vent
88 Upper Mating Portion
89 Lower Mating portion
90 Air Gap

1. An LED lamp comprising:
a core comprising a plurality of elevated sections;
each said elevated section comprising at least one air vent and being configured to dispose an LED support;
a heat sink in conductive heat transfer communication with a corresponding LED support and said core;
each said heat sink comprising a plurality of convective heat transfer fins extending outward from said corresponding LED support;
each said heat transfer fin being gap spaced from adjacent heat transfer fins;
an insulator disposed about each said elevated section of said core and having a light redirecting portion configured to redirect light emitted from LEDs supported on said corresponding LED support;
each said insulator comprising at least one air vent in said light redirecting portion;
each said heat transfer fin and each said corresponding insulator being configured and disposed to provide an air gap therebetween;
a light transmissible panel disposed about a light opening in each said insulator;
each said light transmissible panel having an air gap between an adjacent light transmissible panel; and
each said air vent in each said embossed portion, each said air vent in each said insulator, each said gap space between said heat transfer fins, each said air gap between said heat transfer fins and said corresponding insulator, and each said air gap between said adjacent light transmissible panels being configured and disposed to be in air flow communication with each other and an outside environment.

2. The LED lamp of claim 1 wherein each said light transmissible panel has substantially the same configuration.

3. The LED lamp of claim 1 wherein each said light transmissible panel is removably attached to said corresponding insulator.

4. The LED lamp of claim 1 wherein each said light transmissible panel has a phosphor containing material disposed therewith.

5. The LED lamp of claim 1 wherein each said LED lamp is AC-driven.

6. The LED lamp of claim 1 wherein each said LED lamp is DC-driven.

7. An LED lamp comprising:
a plurality of insulators interconnected to form a geometric shape;
an LED support disposed with each said insulator;
a heat sink disposed about at least one said insulator; and
said at least one said insulator and said heat sink disposed thereabout having an air gap therebetween.

8. The LED lamp of claim 7 further comprising a light transmissible panel disposed about a light opening in each said insulator.

9. The LED lamp of claim 8 wherein each said light transmissible panel has substantially the same configuration.

10. The LED lamp of claim 8 wherein each said light transmissible panel is removably attached to said insulator.

11. The LED lamp of claim 8 wherein each said light transmittable panel has a phosphor containing material disposed therewith.

12. The LED lamp of claim 7 comprising a core configured to dispose said plurality of insulators wherein said core has at least one air vent in flow communication with an outside environment.

13. The LED lamp of claim 7 wherein each said insulator has at least one air vent in flow communication with an outside environment.

14. The LED lamp of claim 12 wherein said core comprises a plurality of elevated sections, each said elevated section being configured to dispose one said LED support outward from a center of said LED lamp.

15. An LED lamp comprising:
a core comprising a plurality of outwardly extending elevated sections; and
each said elevated section being configured to dispose an LED support.

16. The LED lamp of claim 15 wherein each said elevated section is disposed about said core in a substantially uniform pattern.

17. The LED lamp of claim 15 wherein each said elevated section has a configuration selected from the group consisting of round, triangular, rectangular, pentagonal, hexagonal, heptagonal, octagonal, and combinations thereof.

18. The LED lamp of claim 15 wherein each said elevated section has at least one air vent.

19. The LED lamp of claim 15 wherein at least one of said elevated sections is more proximate a base of said LED lamp than at least one other of said elevated sections.

20. The LED lamp of claim 15 further comprising an insulator disposed about each said elevated section and a heat sink disposed about each said insulator, each said insulator and said heat sink disposed thereabout having an air gap therebetween.

21. The LED lamp of claim 15 comprising a control system configured to individually control at least one LED disposed with an LED support.
